(19) United States
(12) Patent Application Publication
(10) Pub. No.: US 2006/0193208 A1
(43) Pub. Date: Aug. 31, 2006

(54) TIMEPIECE WITH SMALL HAND INDICATING MECHANISM

(76) Inventor: Shigeo Suzuki, Chiba-shi (JP)

Correspondence Address: BRUCE L. ADAMS, ESQ., 17 BATTERY PLACE - SUITE 1231, NEW YORK, NY, 10004, US

(21) Appl. No.: 11/360,280

(22) Filed: Feb. 23, 2006

(30) Foreign Application Priority Data
Feb. 25, 2005 (JP) 2005-051535

(51) Int. Cl. G04B 19/24

(52) U.S. Cl. 368/28

(57) ABSTRACT

To realize a timepiece with small hand indicating mechanism capable of forming a plurality of kinds of movement layouts having small hands having different revolution numbers by only changing specifications of portions of parts without changing dimensions and shapes of essential parts of a movement. A movement is provided with a first train wheel rotation center for a first type of train wheel for operating a first small hand rotated by a first speed, and a second train wheel rotation center for a second type of train wheel for operating a second small hand rotated by a second speed at a rotation center the same as that of the above-described small hand. A train wheel for rotating a small hand is arranged at one of the first train wheel rotation center and the second train wheel rotation center. Time information or calendar information can be indicated by a small hand rotated by the first type of train wheel or the second type of train wheel.

### BACKGROUND OF THE INVENTION

1. Field of the Invention

The present invention relates to a timepiece with small hand indicating mechanism capable of indicating information by a small hand. Particularly, the invention relates to a timepiece with small hand indicating mechanism constituted to be able to indicate different information by a small hand by only changing specifications of portions of parts without changing dimensions and shapes of essential parts of a movement.

2. Description of the Prior Art

(1) Explanation of terminology

Generally, a machine body including a portion of driving a timepiece is referred to as “movement”. A state in which a movement is attached with a dial, hands is put into a timepiece case to constitute a finished product is referred to as “complete” of a timepiece. In both sides of a main plate constituting a base plate of a timepiece, a side having glass of a timepiece case, that is, a side having a dial of a timepiece case is referred to as “back side” or “glass side” or “dial side” of a movement. In the both sides of the main plate, a side having a case back of a timepiece case, that is, a side opposed to a dial is referred to as “top side” or “case back side” of a movement. A train-wheel integrated to “top side” of a movement is referred to as “top train wheel”. A train wheel integrated to “back side” of the movement is referred to as “back train wheel”. Generally, “12 o'clock side” indicates a side of being arranged with a graduation in correspondence with 12 o'clock of a dial in an analog type timepiece. “12 o'clock direction” indicates a direction directed to “12 o'clock side” from a center of a main plate or a rotational center of an indicator of an hour hand or the like (hereinafter, referred to as “main plate center”) in an analog type timepiece. Further, “2 o'clock side” indicates a side arranged with a graduation in correspondence with 2 o'clock of a dial in an analog type timepiece. “2 o'clock direction”. indicates a direction directed to “2 o'clock side” from the main plate center.

Further, “3 o'clock side” indicates a side arranged with a graduation in correspondence with 3 o'clock of a dial. “3 o'clock direction” indicates a direction directed to “3 o'clock side” from the main plate center. Further, “6 o'clock side” indicates a side arranged with a graduation in correspondence with 6 o'clock of a dial in an analog type timepiece. “6 o'clock direction” indicates a direction directed to “6 o'clock side” from the main plate center in an analog type timepiece. Further, “9 o'clock side” indicates a side arranged with the graduation in correspondence with 9 o'clock of a dial in an analog type timepiece. “9 o'clock direction” indicates a direction directed to “9 o'clock side” from the main plate center in an analog type timepiece. Further, “10 o'clock side” indicates a side arranged with a graduation in correspondence with 10 o'clock of a dial in an analog type timepiece. “10 o'clock direction” indicates a direction directed to “10 o'clock side” from the main plate center in an analog type timepiece. Further, there is a case of indicating a side arranged with other graduation of a dial, such as “4 o'clock direction”, “4 o'clock side”.

Further, in the specification,, there is a case in which a straight line directed to “3 o'clock side” from the main plate center is simply referred to as “3 o'clock direction”. Similarly, there is a case in which a straight line directed. to “12 o'clockside” from the main plate center is simply referred to as “12 o'clock direction”, a straight line directed to “4 o'clock side” from the main plate center is simply referred to as “4 o'clock direction”, a straight line directed to “6 o'clock side” from the main plate center is simply referred to as “6 o'clock direction”, and a straight line directed to “9 o'clock side” from the main plate center is simply referred to as “9 o'clock direction”. Further, in the specification, a region between “3 o'clock direction” and “4 o'clock direction” is referred to as “3-4 o'clock region”. Similarly, there is a case in which a region between “12 o'clock direction” and “3 o'clock direction” is referred to as “12-3 o'clock region”, a region between “3 o'clock direction” and “6 o'clock direction” is referred to as “3-6 o'clock region”, a region between “6 o'clock direction” and “9 o'clock direction” is referred to as “6-9 o'clock region”, and a region between “9 o'clock direction” and “12 o'clock direction” is referred to as “9-12 o'clock region”.

(2) Timepiece with small hand indicating mechanism of background arts:

(2.1) First type of timepiece with small hand indicating mechanism:

According to a first type of a timepiece with small hand indicating mechanism of a background art, a train wheel for driving an hour hand, a minute hand and a train wheel for driving only a second hand are constituted, and a small second hand is rotated by the train wheel for driving only the second hand (refer to, for example, Patent Reference 1).

(2.2) Second type of timepiece with small hand indicating mechanism:

According to a second type of a timepiece with small hand indicating mechanism of a background, art, a position of a rotational center of a small second hand is constituted to be changed by a men's timepiece and a women's timepiece and a small second hand transmission wheel is constituted to be able to be changed to arrange (refer to, for example, Patent Reference 2).

(2.3) Third type of timepiece with small hand indicating mechanism:

According to a timepiece with small hand indicating mechanism of a third type of a background art, a main plate is provided with a train wheel rotational center of a rotor and a train wheel used for fabricating “center chronograph timepiece” and a train wheel rotational center of a rotor and a train wheel used in fabricating “side chronograph timepiece”, a bridge member is provided with a train wheel rotational center of a rotor and a train wheel used in fabricating “center chronograph timepiece” and a train wheel rotational center of a rotor and a train wheel used in fabricating “side chronograph timepiece”, and the rotor and the train wheel used in fabricating “side chronograph timepiece” having a chronograph hand which is a kind of a small hand are rotatably integrated to the train wheel rotational center of the main plate and the train wheel rotational center of the bridge member (refer to, for example, Patent Reference 3).

(2.4) Fourth type of timepiece with small hand indicating mechanism:

According to a fourth type of a timepiece with small hand indicating mechanism, the timepiece is constituted to indicate normal time and indicate an additional function at at least one position of a center position of a movement, a position on an axis in 12 o'clock direction, a position on an axis in 3 o'clock direction, a position on an axis in 6 o'clock direction, and a position on an axis in 9 o'clock direction (refer to, for example, Patent References 4, 5).
<Patent Reference 1>JP-A-56-84581
<Patent Reference 2>JP-UM-A-2-105191
<Patent Reference 3>JP-A-2004-20421
<Patent Reference 4>JP-A-2-77680.
<Patent Reference 5>JP-A-2002-333490

However, according to the timepieces with small hand indicating mechanism of the background arts, in a movement, in order to provide different indicating styles by using a small hand, a plurality of related parts need to be changed and a large-scaled change in a movement layout is needed. Therefore, when a plurality of movement layouts having small hands of different indicating styles are formed, it is necessary to separately design the respective movements and prepare a number of working machines, dies and the like for working constituent parts of the respective movements. Therefore, in fabricating a timepiece with small hand indicating mechanism of background arts, there poses a problem that much time period is needed in switching part working operation, further, a number of steps of fabricating parts is increased.

It is an object of the invention to realize a timepiece with small hand indicating mechanism constituted to be able to form a plurality of kinds of movement layouts having different revolution numbers by only changing specifications of portions of parts.

Further, it is other object of the invention to realize a timepiece with small hand indicating mechanism in which much time period is not needed in switching part working operation and a number of steps of fabricating parts is small.

### SUMMARY OF THE INVENTION

The invention is a timepiece with small hand indicating mechanism including a main plate constituting a base plate of a movement, a winding stem for correcting indication, a switching mechanism for switching a position of the winding stem, a dial for indicating time information, and a small hand for indicating time information or calendar information, wherein the movement is provided with a first train wheel rotational center for a first type of a train wheel for operating a first small hand rotated by a first speed, and a second train wheel rotational center for a second type of a train wheel for operating a second small hand rotated by a second speed at a rotational center the same as the rotational center of the small hand. The first rotational center of the first small hand is arranged at a position between a main plate center of the main plate and a main plate outer shape portion of the main plate. The first train wheel rotational center is provided with a train wheel guide portion for rotatably guiding a train wheel member rotated centering on the position. The second train wheel rotational center is provided with a train wheel guide portion for rotatably guiding a train wheel member rotated centering on the position. A train wheel for indicating the time information or the calendar information is arranged rotatably at one of the first train wheel rotational center and the second train wheel rotational center. The time information or the calendar information can be indicated by the small hand rotated by the first type of the train wheel or the second type of the train wheel by constituting a rotational center by the position between the main plate center and the outer shape portion of the main plate.

By the constitution, a plurality of kinds of movement layouts having different revolution numbers can be formed by only changing specifications of portions of parts without changing dimensions and shapes of a number of essential parts of the movement. It is preferable in the timepiece with small hand indicating mechanism of the invention that the first type of the train wheel is a train wheel constituting a date feeding mechanism indicating “date” by a first small hand, and the second type of the train wheel is a train wheel constituting a small second hand mechanism for indicating “second” by a second small hand. By the constitution, a movement layout indicating “date” and a movement layout indicating “second” can be realized by only changing specifications of portions of parts without changing dimensions and shapes of a number of essential parts of the movement.

Further, it is possible in the timepiece with small hand indicating mechanism of the invention that the train wheel constituting the small second hand mechanism includes a second transmission wheel rotated integrally with a wheel constituting a top train wheel. By the constitution, there can be realized a timepiece with small hand indicating mechanism which does not need much time in switching part working operation and in which a number of steps of fabricating parts is small. Further, it is possible to constitute the timepiece with small hand indicating mechanism of the invention such that the first train wheel rotational center is integrated with a train wheel constituting a date feeding mechanism. Further, it is possible to constitute the timepiece is small hand indicating mechanism of the invention such that the train wheel constituting the date feeding mechanism includes an intermediate date indicator driving wheel rotated integrally with an hour wheel. Further, it is possible to constitute the timepiece with small hand indicating mechanism of the invention such that the first train wheel rotational center can be integrated with a train wheel constituting a 24 hour indicating mechanism. By the constitution, there can be realized a timepiece with small hand indicating mechanism which does not need much time in switching part working operation and in which a number of steps of fabricating parts is small.

Further, it is possible to constitute the timepiece with small hand indicating mechanism of the invention such that the train wheel constituting the 24 hour indicating mechanism includes a 24 hour intermediate wheel rotated integrally with an hour wheel. By the constitution, there can be provided a timepiece with small hand indicating mechanism capable of realizing a plurality of movement layouts. By the constitution, there can be realized a timepiece with small hand indicating mechanism which does not need much time in switching part working operation and in which a number of fabricating parts is small.

### BRIEF DESCRIPTION OF THE SEVERAL VIEWS OF THE DRAWINGS

A preferred form of the present invention is illustrated in the accompanying drawings in which:

FIG. 1 is a plane view showing an outline structure viewed from a top side of the movement according to an embodiment of a timepiece with small hand indicating mechanism of the invention;

FIG. 2 is a plane view showing a top train wheel mechanism and the top side of the movement according to the embodiment of the timepiece with small hand indicating mechanism of the invention;

FIG. 3 is a plane view showing an outline structure viewed from a back side of the movement with regard to portions of a date feeding mechanism and a date correcting mechanism according to the embodiment of the timepiece with small hand indicating mechanism of the invention;

FIG. 4 is a partial sectional view showing portions of the date feeding mechanism and the date correcting mechanism according to the embodiment of the timepiece with small hand indicating mechanism of the invention;

FIG. 5 is a plane view showing portions of a dial and a hand of a complete having a date hand constituting a small hand indicating date according to the embodiment of the timepiece with small hand indicating mechanism of the invention;

FIG. 6 is a plane view showing an outline structure viewed. from a back side of the movement with regard to a portion of a small second hand train wheel according to the embodiment of the timepiece with small hand indicating mechanism of the invention;

FIG. 7 is a partial sectional view showing the portion of the small second hand train wheel according to the embodiment of the timepiece with small hand indicating mechanism of the invention;

FIG. 8 is a plane view showing portions of a dial and a hand of a complete having a small second hand constituting a small hand indicating second according to an embodiment of a timepiece with small hand indicating mechanism of the invention;

FIG. 9 is a plane view showing an outline view viewed from a back side of a movement with regard to a portion of a 24 hour hand train wheel according to an embodiment of a timepiece with small hand indicating mechanism of the invention;

FIG. 10 is a partial sectional view showing the portion of the 24 hour hand train wheel according to the embodiment of the timepiece with small hand indicating mechanism of the invention; and

FIG. 11 is a plane view showing portions of a dial and a hand of a complete having a 24 hour hand constituting a small hand showing time by 24 hour system according to the embodiment of the timepiece with small hand indicating mechanism of the invention.

### DETAILED DESCRIPTION OF THE PREFERRED EMBODIMENTS

An embodiment of the invention will be explained in reference to the drawings as follows.

(1) Structure of total of movement

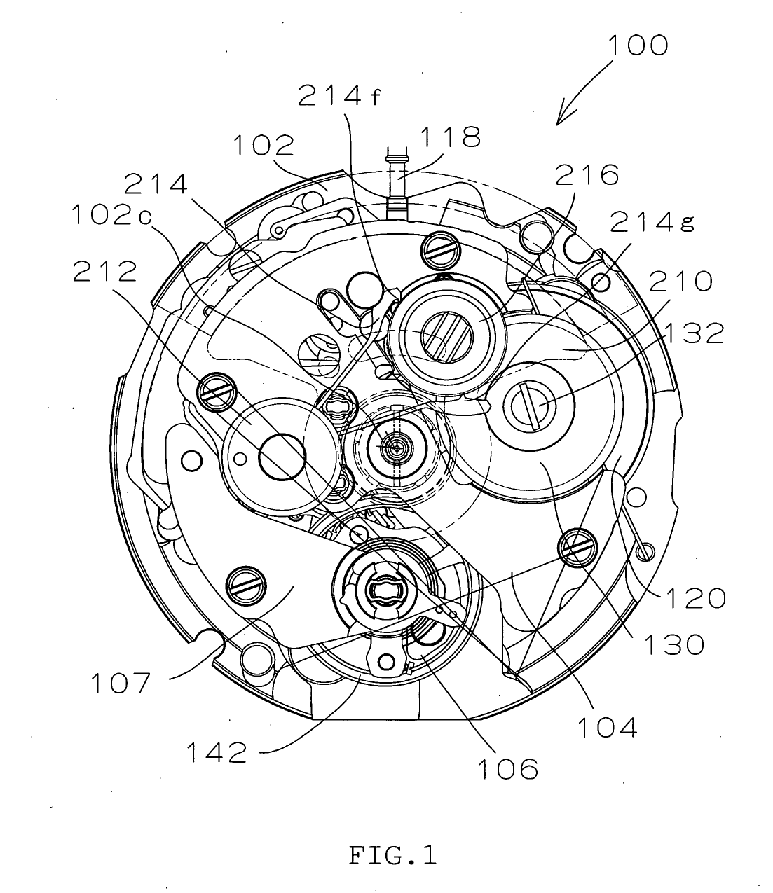

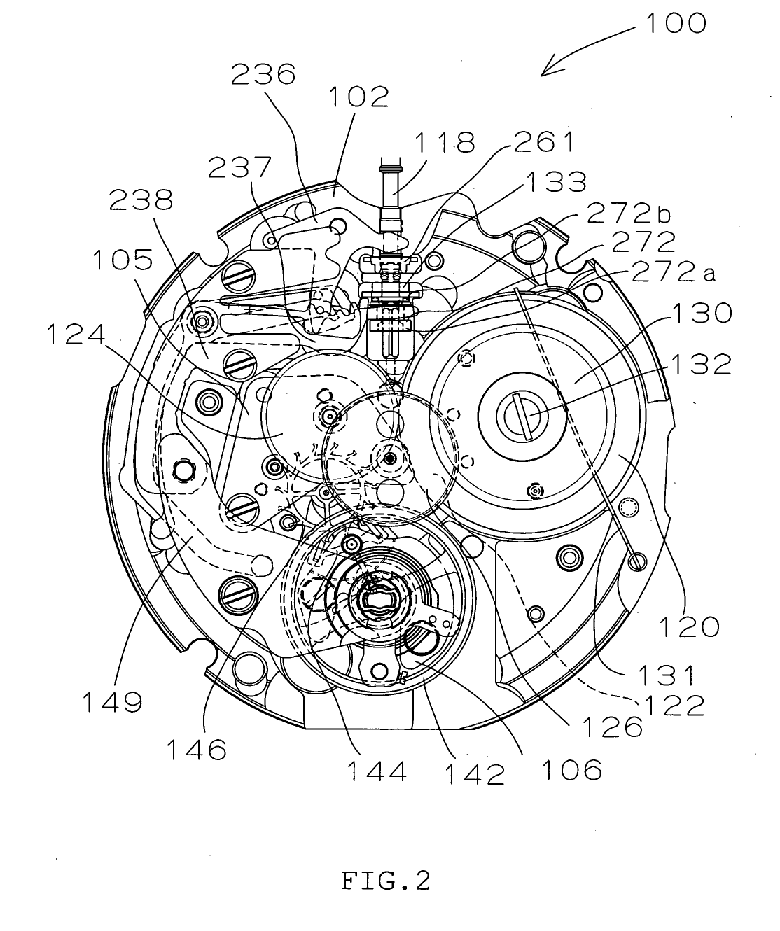

In reference to FIG. 1 and FIG. 2 a timepiece with small hand indicating mechanism of the invention is provided with a movement 100. The movement 100 is provided with a main plate 102, a first bridge 104, a second bridge 105, a pallet fork bridge 106, and a balance bridge 107. A winding stem 118 is integrated to the main plate 102 rotatably and movably in an axis line direction.

A top side of the movement 100 is arranged with a top train wheel, an escapement mechanism, a speed control mechanism, an automatic winding mechanism, a hand winding mechanism, and a switching apparatus. Or, the hand winding mechanism may be deleted. Or, the switching apparatus may be arranged on a back side of the movement 100. Or, the hand winding mechanism may be arranged on the top side of the movement 100 and the automatic winding mechanism maybe omitted. The back side of the movement 100 is constituted to be able to arrange a back train wheel, a date indicating mechanism, and a date correcting mechanism. Further, the back side of the movement 100 is constituted to be able to arrange a small second hand train wheel, or to be able to arrange a 24 hour hand train wheel. The top train wheel is rotatably supported by the main plate 102, the first bridge 104, the second bridge 105. The back train wheel is rotatably supported by the main plate 102, a second main plate 112, and a holding member or the like.

(2) Constitution of top wheel

Next, a constitution of the top train wheel will be explained. In reference to FIG. 1 and FIG. 2, a barrel complete 120 is rotatably supported by the first bridge 104 and the main plate 102. The barrel complete 120 includes a mainspring, a barrel stem, a barrel wheel, and a barrel lid. The mainspring constitutes a power source of a mechanical timepiece. By winding back (releasing) the mainspring, the barrel wheel is rotated in one direction, and time information is indicated by indicators (hour hand, minute hand, second hand and the like) via rotation of the top train wheel and the back train wheel. Rotation of the barrel wheel rotated by power of the mainspring is controlled by a speed control apparatus and an escapement apparatus. The speed control apparatus includes a balance with hairspring 142. The escapement apparatus includes a pallet fork 144 and an escape wheel & pinion 146. The balance with hairspring 142 is rotatably supported by the balance bridge 107 and the main plate 102. The pallet fork 144 is rotatably supported by the pallet fork bridge 106 and the main plate 102. The escape wheel & pinion 146 is rotatably supported by the first bridge 104 and the main plate 102. A center wheel & pinion 122 is constituted to rotate by one rotation per hour by rotation of the barrel wheel. The center wheel & pinion 122 is rotatably supported by the second bridge 105 and the main plate 102. A third wheel & pinion 124 is constituted to rotate by rotation of the center wheel & pinion 122. A cannon pinion (not illustrated) is attached to the center wheel & pinion 122 to be able to be slipped. A rotation center of the center wheel & pinion 122 is arranged at a main plate center 102c.

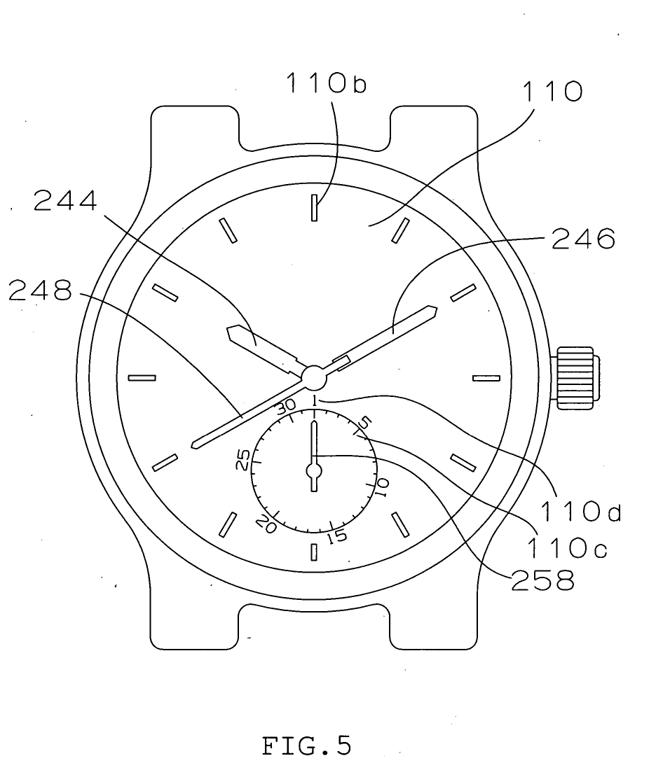

The third wheel & pinion 124 is rotatably supported by the first bridge 104 and the main plate 102. A fourth wheel & pinion 126 is constituted to rotate by one rotation per minute by rotation of the third wheel & pinion, 124. The fourth wheel & pinion 126 is rotatably supported by the first bridge 104 and the main plate 102. A rotational speed of the fourth wheel & pinion 126 is constituted to be controlled by the escape wheel & pinion 146. A rotational speed of the escape wheel & pinion 146 is constituted to be controlled by the pallet fork 144. Oscillating movement of the pallet fork 144 is constituted to be controlled by the balance with hairspring 142. The top train wheel includes a center wheel & pinion 122, the third wheel & pinion 124, the fourth wheel & pinion 126. In reference to FIG. 5, a minute hand 246 attached to the cannon pinion is constituted to indicate “minute”. A second hand 248 attached to the fourth wheel & pinion 126 is constituted to indicate “second”. In reference to FIG. 1 and FIG. 2, a rotation center of the fourth wheel & pinion 126 and a rotational center of the center wheel & pinion 122 are constituted to be disposed at the same position. That is, the rotational center of the fourth wheel & pinion 126 is arranged at the main plate center 102c.

A ratchet hole portion of a ratchet wheel 130 is integrated to a square shaft portion (not illustrated) provided at an upper portion (side of the first bridge 104) of the barrel stem of the barrel complete 120. The ratchet wheel 130 is supported to rotate integrally with the barrel complete by a square hole setscrew 132. The ratchet wheel 130 can be rotated only in a direction the same as a direction of rotating the barrel complete 120. A click 131 for constituting a rotation rectifying member of the ratchet wheel is provided at the first bridge 104 to rectify rotation of the ratchet wheel 130 only in one direction. By the click 131, the ratchet wheel 130 can be hampered from rotating in a direction reverse to a direction of rotating the barrel wheel 120. According to a constitution for providing the hand winding mechanism, the hand winding mechanism includes a clutch wheel 272, a winding pinion 133, a crown wheel (not illustrated) and a crown transmission wheel (not illustrated). The winding wheel 133 is constituted to rotate by rotation in one direction of the clutch wheel 272. The crown transmission wheel is constituted to rotated via rotation of the crown wheel by rotation of the winding pinion 133. The ratchet wheel 130 is constituted to rotate in the clockwise direction by rotation of the crown transmission wheel. The mainspring is constituted to be able to be wound by rotating the ratchet wheel 130.

(3) Constitution of automatic winding mechanism:

Next, a constitution of an automatic winding mechanism will be explained. In FIG. 1, an automatic winding mechanism for winding up the mainspring is provided on the top side of the movement 100. The automatic winding mechanism includes an oscillating weight 210, a first reduction wheel 212, a pawl lever 214, and a second reduction wheel & pinion 216. The oscillating weight 210 is rotatably integrated to the first bridge 104 via a ball bearing. The first reduction wheel 212 is rotatably supported by the first bridge 104 and the main plate 102. A wheel portion of the first reduction wheel 212 is constituted to be brought in mesh with an oscillating weight pinion of the oscillating weight 210. A hole (not illustrated) of a base portion of the pawl lever 214 is rotatably integrated to an eccentric cam portion (not illustrated) of the first reduction wheel 214. The pawl lever 214 includes two pawl portions, that is, a pull pawl 214f and a push pawl 214g. The second reduction wheel & pinion 216 is rotatbly supported by the first bridge 104. The pull pawl 214f and the push pawl 214g of the pawl lever 214 are constituted to be brought in mesh with ratchet teeth (not illustrated) of the second reduction wheel & pinion 216. The pawl lever 214 is constituted to be operated by rotating the first reduction wheel 212 when the oscillating weight 210 is rotated. The pull pawl 214f of the pawl lever 214 is constituted to be able to rotate the second reduction wheel & pinion 216 only in one direction (in counterclockwise direction in FIG. 2). The push pawl 214g of the pawl lever 214 is constituted to be able to rotate the second reduction wheel & pinion 216 only in one direction (in counterclockwise direction in FIG. 2). Therefore, when the oscillating weight 210 is rotated, the pawl lever 214 is operated, and based on rotation of the second reduction wheel & pinion 216, the ratchet wheel 130 is constituted to rotate in the clockwise direction. As a result, when the oscillating weight 210 is rotated, the-mainspring can be wound up by operating the automatic winding mechanism.

(4) Constitution of back train wheel

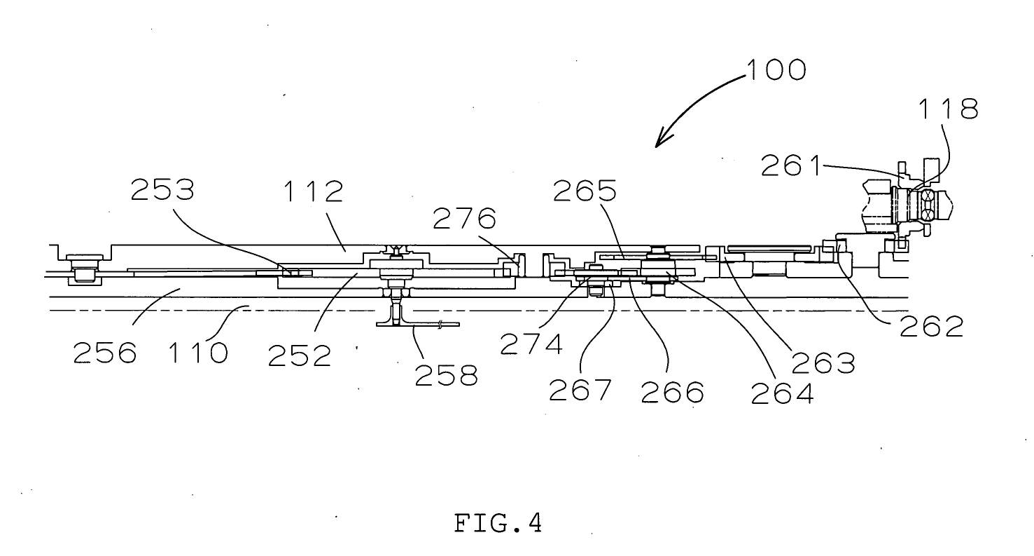

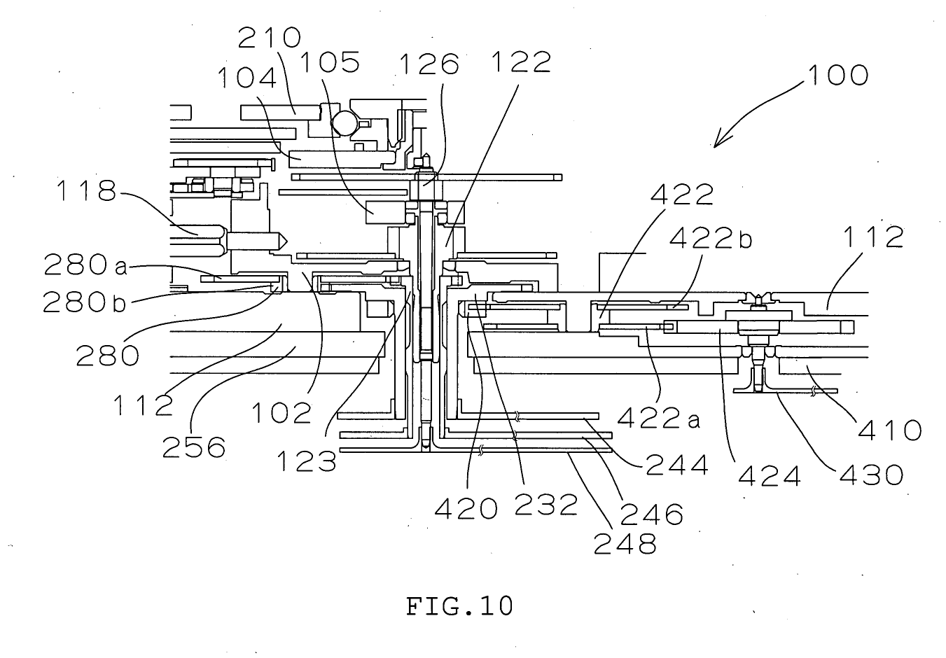

Next, a constitution of the back train wheel will be explained. In reference to FIG. 4 and FIG. 10, the movement 100 is provided with the second main plate 112. The second main plate 112 is arranged on a dial side of the main plate 102. The back train wheel includes a minute wheel 280 and an hour wheel 232. The minute wheel 280 is constituted to rotate by rotation of the center wheel & pinion 122. The cannon pinion 123 is constituted to be able to slip relative to the center wheel of the center wheel & pinion 122. The minute wheel 280 includes a minute wheel 280a and a minute pinion 280b. The minute wheel 280a is constituted to be brought in mesh with a gear portion of the cannon pinion 123. The minute pinion 280b is constituted to be brought in mesh with a gear portion of the hour wheel 232. The hour wheel 232 is constituted to rotate by one rotation per 12 hours by rotation of the minute wheel 280. The rotational center of the hour wheel 232 and the rotational center of the center wheel & pinion 122 are constituted to be disposed at the same position. That is, the rotational center of the hour wheel 232 is arranged at the main plate center 102c. In reference to FIG. 5, a minute hand 246 attached to the hour pinion is constituted to indicate “minute”. A second hand 248 attached to the fourth wheel & pinion 126 is constituted to indicate “second”. An hour hand 244 attached to the hour wheel 232 is constituted to indicate “hour”. That is, the movement 100 is provided with a train wheel capable of attaching the hour hand 244, the minute hand 246, the second hand 248 to constitute a “middle three hands timepiece” in which the rotational center of the hour hand 244, the rotational center of the minute hand 246, the rotational center of the second hand 248 are disposed at the same position. A plurality of abbreviated letters 110b for indicating time are provided at a dial 110.

(5) Constitution of switching mechanism

Next, a constitution of the switching mechanism will be explained. The timepiece of the invention is provided with a switching mechanism and a time setting mechanism to set time of the timepiece. In reference to FIG. 2, the switching mechanism is constituted to include a setting lever 236, a yoke 237, a yoke holder 238. The time setting mechanism includes the winding stem 118 and a clutch wheel 272. The square, hole portion of the clutch wheel 272 is integrated to a square shaft portion of the winding stem 118. A position of the winding stem 118 in a direction along a center axis line of the winding stem 118 is determined by the switching apparatus (setting lever, yoke holder and the like). A position of the clutch wheel 272 in a direction along the center axis line of the winding stem 118 is determined by the switching apparatus (clutch lever, yoke, yoke holder and the like). The clutch wheel 272 is provided with A teeth 272a disposed on a side proximate to a center portion of the movement 100 and B teeth 272b disposed on a side proximate to an outer shape portion of the movement 100. The B teeth 272b of the clutch wheel 272 is constituted by a ratchet gear. The winding pinion 133 is provided with a winding small gear constituted to be able to be brought in mesh with the B teeth 272b of the clutch wheel 272 and a winding large gear constituted to be able to be brought in mesh with the gear portion of the crown wheel. The winding small gear is constituted by a ratchet gear.

In a state of setting the winding stem 118 to 0 stage and in a state of setting the winding stem 118 to 1 stage, the A teeth 272a of the clutch wheel 272 is constituted not to be brought in mesh with the wheel portion of the hour wheel. In the state of wetting the winding stem 118 to 0 stage, the B teeth 272b of the clutch wheel 272 is constituted to be brought in mesh with the small gear of the winding pinion 133. In the state of setting the winding stem 118 to 1 stage, the B teeth 272b of the clutch wheel 272 is constituted not to be brought in mesh with the small gear of the winding pinion 133. In a state of setting the winding stem 118 to 2 stage, the A teeth 272a of the clutch wheel 272 is constituted to be brought in mesh with the gear portion of a minute wheel 280a. In the state of setting the winding stem 118 to 2 stage, the B teeth 272b of the clutch wheel 272 is constituted not to be brought in mesh with the small gear of the winding pinion. When the winding stem 118 is rotated in one direction in the state of setting the winding stem 118 to 0 stage, the clutch wheel 272 is rotated along with the winding stem 118, the ratchet wheel 130 is constituted to be rotated via rotation of the winding pinion 133, the crown wheel, a crown transmission wheel to be able to wind up the mainspring. When the winding stem 118 is rotated in other direction in the state of setting the winding stem 118 to 0 stage, although the clutch wheel 272 is rotated along with the winding stem 118, the winding pinion 133 is constituted not to rotate. In the state of setting the winding stem 118 to 2 stage, a balance rectifying lever 149 for rectifying rotation of the balance with hairspring 142 is provided to rotate based on rotation of the setting lever 236.

(6) Constitution of date feeding mechanism

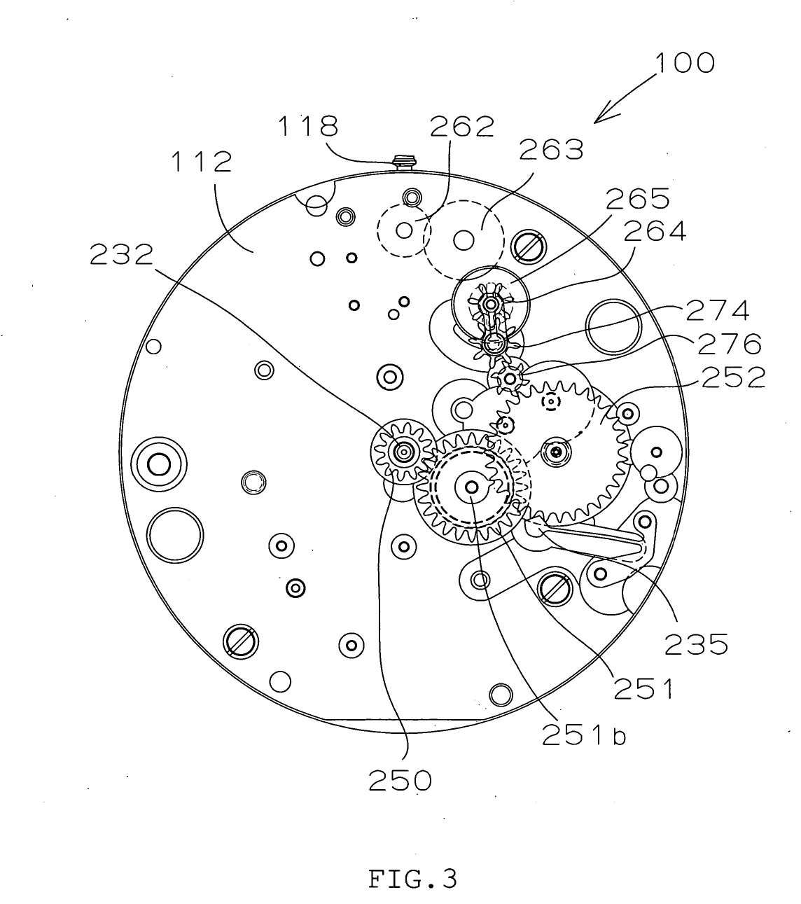

Next, a constitution of a date feeding mechanism will be explained. In reference to FIG. 3 and FIG. 4, according to a constitution of capable of indicating “date” by a small hand, the date feeding mechanism is constituted to operate based on rotation of the back train wheel. The date feeding mechanism includes an intermediate date indicator driving wheel 250, a date indicator driving wheel 251, and a date star wheel 252. The intermediate date indicator driving wheel 250 is constituted to be integral with the hour wheel 232. Therefore, the intermediate date indicator driving wheel 250 is constituted to rotate by rotating the hour wheel 232. The date indicator driving wheel 251 is constituted to rotate by rotating the intermediate date indicator driving wheel 250. The date star wheel 252 is constituted to rotate by once per day (1/31) by a date indicator driving finger 251b provided at the date indicator driving wheel 251. The date star wheel 252 is constituted to rotate by one rotation of per 31 days. A position in a rotational direction of the date star wheel 252 is rectified by a date jumper 253.

In reference to FIG. 5, a date hand 258 attached to the date star wheel 252 is constituted to indicate “date”. It is preferable to arrange a position of a rotational center of the date hand 258 in “6 o'clock direction”, between the rotational center of the center wheel & pinion 122 and an outer peripheral portion of the main plate 102. Pluralities of abbreviated letters 110c and numerals 110d for indicating date are provided at the dial 110. For example, the numerals 110d are constituted by “1”, “5”, “10”, “15”, “20”, “25”, “30” or the like. As has been explained above, the movement 100 of the invention can indicate “hour” by the hour hand 244 attached to the hour wheel 232, indicate “minute” by the minute hand 246 attached to the cannon pinion, indicate “second” by the second hand 248 attached to the fourth wheel & pinion 126 and indicate “date” by the date hand 258 attached to the date star wheel 252 a rotational center of which is arranged in “6 o'clock direction”.

In reference to FIG. 3 and FIG. 4, a second train wheel bridge 256 is arranged between the second main plate 112 and the dial 110. The date indicator driving wheel 251 is arranged rotatably at the second main plate 112. The wheel portion of the date indicator driving wheel 251 is arranged between the second main plate 112 and the second train wheel bridge 256. A center hole of the date indicator driving wheel 251 is integrated rotatably to a shaft portion provided at the second main plate 112. The date star wheel 252 is arranged rotatably at the second main-plate 112 and the second train wheel bridge 256. A lower shaft portion of the date star wheel 252 is rotatably integrated to a bearing portion provided at the second main plate 112. An upper shaft portion of the date star wheel 252 is rotatably integrated to a bearing portion provided at the second train wheel bridge 256. The wheel portion of the date star wheel 252 is arranged between the second main plate 112 and the second train wheel bridge 256. The date jumper 253 is arranged between the second main plate 112 and the second train wheel bridge 256. It is preferable to arrange the rotational center of the date star wheel 252 in “6 o'clock direction”, between the rotational center of the center wheel & pinion 122 and the outer peripheral portion of the main plate 102. It is preferable to arrange a rectifying portion provided at a front end of a spring portion of the date jumper 253 at a region between “6 o'clock direction” and “7 o'clock direction” (that is, “6-7 o'clock region”). It is preferable to arrange the rotational center of the date indicator driving wheel 251 at a region between “6 o'clock direction” and “7 o'clock direction” (that is, “6-7 o'clock region”).

(7) Constitution of date correcting mechanism

Next, a constitution of a date correcting mechanism will be explained. The timepiece of the invention can be provided with a date correcting mechanism for correcting indication of date by the date star wheel 252. In reference to FIG. 3 and FIG. 4, a back side of the movement 100 is provided with a date correcting mechanism for correcting indication of date by the date star wheel 252. The date correcting mechanism is constituted to include a first corrector setting transmission wheel 261, a second corrector setting transmission wheel 262, a third corrector setting transmission wheel 263, an oscillation transmitting wheel 264, an oscillating wheel 274, and a date corrector setting wheel 276. An intermediate date corrector setting transmission wheel 265 is fixed to the oscillation transmitting wheel 264. An oscillating wheel lever 266 is fixed to the oscillation transmitting wheel 264 via a slipping mechanism. The oscillating wheel 274 is arranged rotatably to the oscillating wheel lever 266. An oscillating wheel seat 267 supports the oscillating wheel 274 rotatably to the oscillating wheel lever 266.

In the state of setting the winding stem 118 to 1 stage, the first corrector setting transmission wheel 261 is supported to fit to a first corrector setting transmission wheel guide portion of the winding stem 118. That is, in the state of setting the winding stem 118 to 1 stage, the first corrector setting transmission wheel 261 and the winding stem 118 are arranged to be coaxial with each other, and when the winding stem 118 is rotated, the first corrector setting transmission wheel 261 is constituted to rotate integrally with the winding stem 118. The second corrector setting transmission wheel 262 is rotatably supported by the second main plate 112. A center hole of the second corrector setting transmission wheel 262 is integrated rotatably to a shaft portion of a pin with flange fixed to the second main plate 112. The third corrector setting transmission wheel 263 is rotatably supported by the second main plate 112. A center hole of the third corrector setting transmission wheel 263 is rotatably integrated to a shaft portion of a pin with flange fixed to the second main plate 112.

The oscillation transmitting wheel 264 is rotatably supported by the second main plate 112 and the second train wheel bridge 256. A lower shaft portion of the oscillation transmitting wheel 264 is rotatably integrated to a bearing portion provided at a second main plate 112. An upper shaft portion of the oscillation transmitting wheel 264 is rotatably integrated to a bearing portion provided at the second train wheel bridge 256. A date corrector setting wheel 276 is rotatably supported by the second main plate 112. A center hole of the date corrector setting wheel 276 is rotatably integrated to a shaft portion provided at the second main plate 112. The wheel portion of the date corrector setting wheel 276 is constituted to be brought in mesh with the wheel portion of the date star wheel 252.

When the winding stem 118 is rotated in one direction, the oscillation transmitting wheel 264 is rotated via rotation of the first corrector setting transmission wheel 261, the second corrector setting transmission wheel 262, the third corrector setting transmission wheel 263, and the oscillating wheel 274 supported by the oscillating wheel lever 266 is moved to a position of being brought in mesh with the date corrector setting wheel 276. Under the state, the wheel portion of the date corrector setting wheel 276 is constituted to be able to rotate the date star wheel 252 by rotating the date corrector setting wheel 276 by rotation of the oscillating wheel 274 by rotating the winding stem 118 in one direction. When the winding stem 118 is rotated in other direction, the oscillation transmitting wheel 264 is rotated, and the oscillating wheel 274 supported by the oscillating wheel lever 266 is moved to a position of being remote from the date corrector setting wheel 276. Under the state, the date corrector setting wheel 276 is constituted not to be able to be rotated by rotation of the oscillating wheel 274 even when the winding stem 118 is rotated in other direction.

(8) Constitution of hand setting mechanism

In reference to FIG. 3, FIG. 4, and FIG. 10, in the state of setting the winding stem 118 to 0 stage, it is constituted that even when the winding stem 118 is rotated, the first corrector setting transmission wheel 261 cannot be rotated, and also the minute wheel 280 cannot be rotated. In the state of setting the winding stem 118 to 2 stage, it is constituted that even when the winding stem 118 is rotated, the first corrector setting transmission wheel 261 cannot be rotated. In reference to FIG. 2, it is constituted that in the state of setting the winding stem 118 to 2 stage, the hands can be set. In the state of drawing the winding stem 118 to 2 stage, it is constituted that the A teeth 272a of the clutch wheel 272 can be brought in mesh with the minute wheel 280a of the minute wheel 280. In the state of drawing the winding stem 118 to 2 stage, it is constituted that by rotating the winding stem 118, the cannon pinion of the center wheel & pinion 122 and the hour wheel 232 can be rotated via rotation of the clutch wheel 272 and rotation of the hour wheel 280. When the hands are set in the state of drawing the winding stem 118 to 2 stage, it is constituted that the cannon pinion 123 can be slipped relative to a center wheel of the center wheel & pinion 122.

(9) Structure of small second hand mechanism:

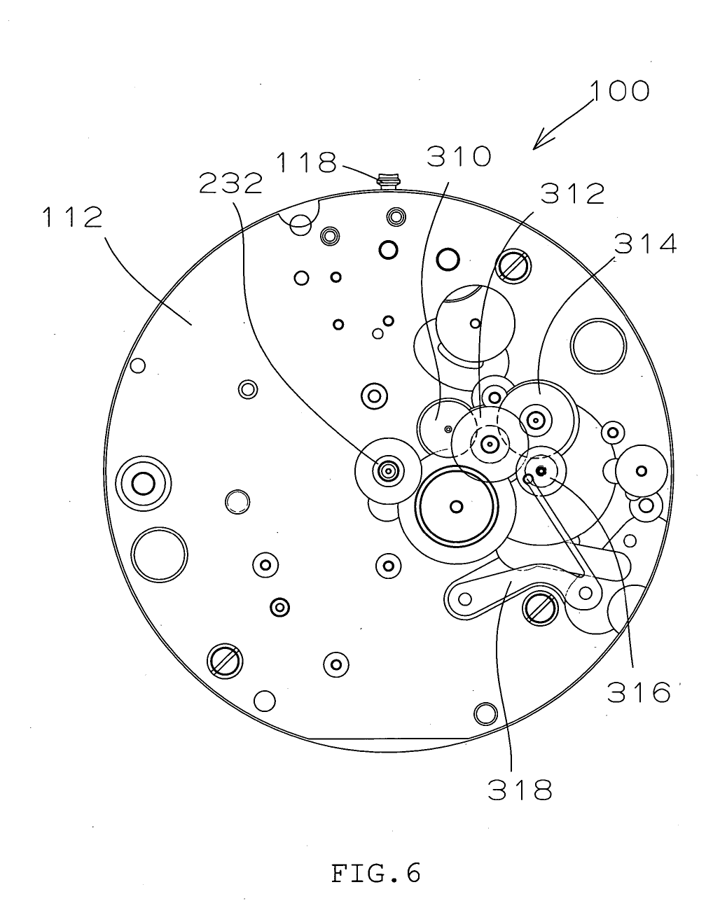

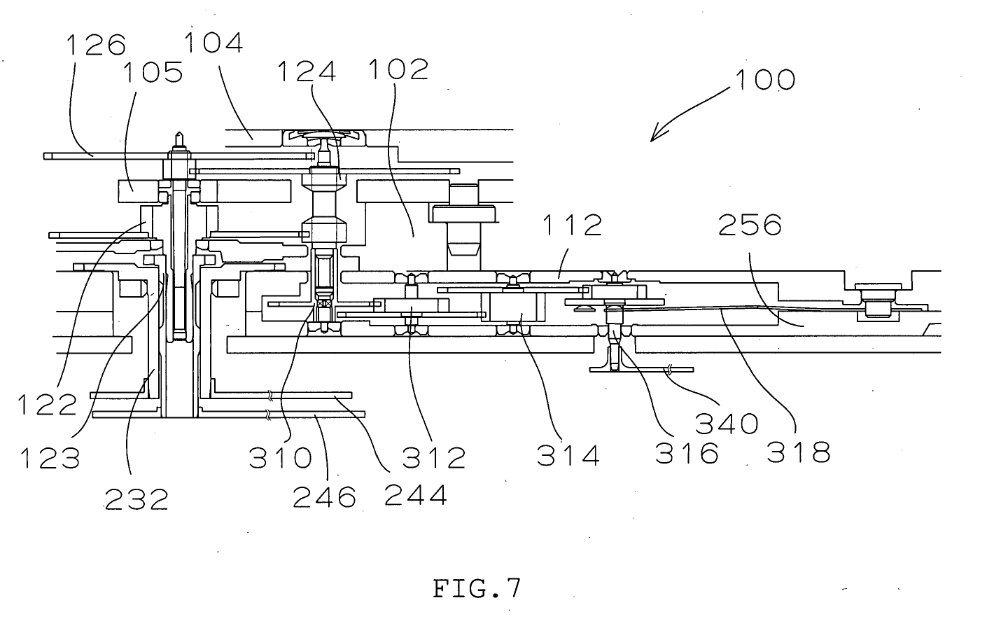

Next, a structure of a small second hand mechanism will be explained. In reference to FIG. 6 and FIG. 7, in the timepiece with small hand indicating mechanism of the invention, a small second hand mechanism for indicating second by a small second hand can be provided to the movement 100 without integrating a date feeding mechanism and the date correcting mechanism. The center wheel & pinion 122 is constituted to rotate based on rotation of the barrel complete 120. A third wheel & pinion 124 is constituted to rotate based on rotation of the center wheel & pinion 122. The fourth wheel & pinion 126 is constituted to rotate based on rotation of the third wheel & pinion 124. An upper shaft portion of the center wheel & pinion 122 is rotatably supported by the second bridge 105. A lower shaft portion of the center wheel & pinion 122 is rotatably supported by the main plate 102.

The third wheel & pinion 124 includes an upper shaft portion, a wheel portion, a pinion portion, a middle guide shaft portion, a square shaft portion, a lower guide shaft portion, and a lower shaft portion. The upper shaft portion of the third wheel & pinion 124 is rotatably supported by the first bridge 104. The lower shaft portion of the third wheel & pinion 124 is rotatably supported by the second train wheel bridge 256. The pinion portion of the third wheel & pinion 124 is constituted to be brought in mesh with the wheel portion of the center wheel & pinion 122. The wheel portion of the third wheel & pinion 124 is constituted to be brought in mesh with the pinion portion of the fourth wheel & pinion 126. The cannon pinion 123 is attached to be able to slip relative to an outer peripheral portion of a lower shaft portion of the center wheel & pinion 122. The hour wheel 232 is rotatably integrated to the outer peripheral portion of the cannon pinion 123. The hour hand 244 is attached to the hour wheel 232. The minute wheel 246 is attached to the cannon pinion 123.

A first second transmission wheel 310 is integrated to rotate integrally with the third wheel & pinion 124. A center hole of the first second transmission wheel 310 is integrated to the middle guide shaft portion, the square shaft portion, the lower guide shaft portion of the third wheel & pinion 124. A square hole portion of the first second transmission wheel 310 is constituted to be fixed by being fitted to the square shaft portion provided to an upper side of the lower shaft portion of the of the third wheel & pinion 124. The wheel portion of the first second transmission wheel 310 is arranged between the second main plate 112 and the second train wheel bridge 256. A second second transmission wheel 312 is constituted to rotate by rotation of the first second transmission wheel 310. A pinion portion of the second second transmission wheel 312 is constituted to be brought in mesh with a wheel portion of the first second transmission wheel 310. An upper shaft portion of the second second transmission wheel 312 is rotatably supported by the second train wheel bridge 256. A lower shaft portion of the second second transmission wheel 312 is rotatably supported by the second main plate 112. A wheel portion of the second second transmission wheel 312 is arranged between the second main plate 112 and the second train wheel bridge 256.

A third second transmission wheel 314 is constituted to rotate by rotation of the second second transmission wheel 312. A pinion portion of the third second transmission wheel 314 is constituted to be brought in mesh with a wheel portion of the second second transmission wheel 312. An upper shaft portion of the third second transmission wheel 314 is rotatably supported by the second train wheel bridge 256. A lower shaft portion of the third second transmission wheel 314 is rotatably supported by the second main plate 112. A wheel portion of the third second transmission wheel 314 is arranged between the second main plate 112 and the second train wheel bridge 256.

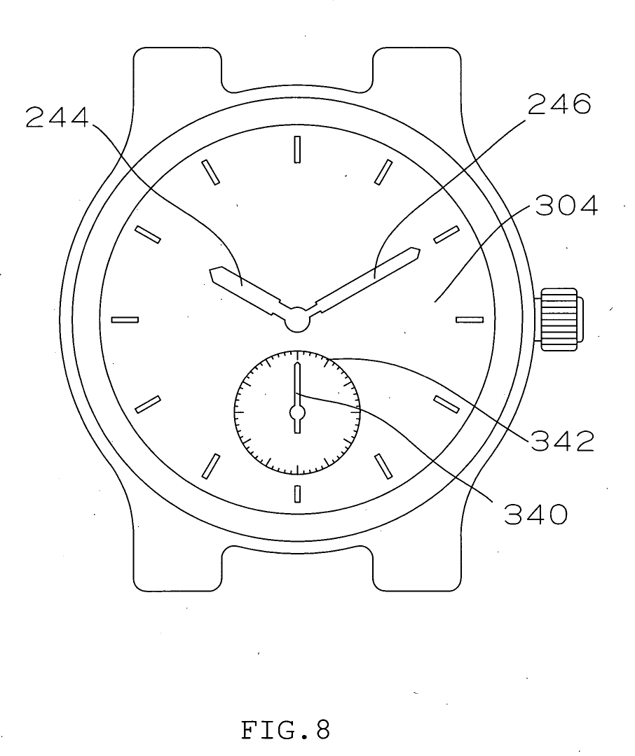

A small second wheel 316 is constituted to rotate by rotation of the third second transmission wheel 314. A wheel portion of the small second wheel 316 is constituted to be brought in mesh with the wheel portion of the third second transmission wheel 314. An upper shaft portion of the small second wheel 316 is rotatably supported by the second train wheel bridge 256. A lower shaft portion of the small second wheel 316 is rotatably supported by the second main plate 112. The wheel portion of the small second wheel 316 is arranged between the second main plate 112 and the second train wheel bridge 256. A rotational center of the small second wheel 316 is arranged at a position the same as the rotational center of the date star wheel 252. That is, it is preferable to arrange a rotational center of the small second wheel 316 in “6 o'clock direction” between the rotational center of the center wheel & pinion 122 and the outer peripheral portion of the main plate 102. The small second wheel 316 is constituted to rotate by one rotation per minute. A small second wheel holder 318 is provided for exerting an elastic force to the small second wheel 316. A front end portion of a spring portion of the small second wheel holder 318 is constituted to be brought into contact with the small second wheel 316. A small second hand 340 is attached to the small second wheel 316. In reference to FIG. 8, an abbreviated letter 342 for indicating “second” is provided at a dial 304. It is constituted that information with regard to “second” constituting time information can be indicated by the small second hand 340 and the abbreviated letter 342 or the like.

In reference to FIG. 6, it is preferable to arrange the rotational center of the first second transmission wheel 310 at a region between “4 o'clock direction” and “5 o'clock direction” (that is, “4-5o'clock region”). It is preferable to arrange the rotational center of the second second transmission wheel 312 at a region between “5o'clock direction” and “6 o'clock direction” (that is, “5-6 o'clock region”). It is preferable to arrange a rotational center of the third second transmission wheel 314 at a region between “5o'clock direction” and “6 o'clock direction” (that is, “5-6 o'clock region”). It is preferable to arrange the spring portion of the small second wheel holder 318 at a region between “6 o'clock direction” and “7 o'clock direction” (that is,. “6-7 o'clock region”). As has been explained above, in reference to FIG. 8, the movement 100 of the invention can indicate “hour” by the hour hand 244 attached to the hour wheel 232, indicate “minute” by the minute hand 246 attached to the cannon pinion 123, display “second” by the small second hand 340 attached to the small second wheel 316 a rotational center of which is arranged in “6 o'clock direction”. According to the constitution, it is not necessary to attach the second hand 248 to the fourth wheel & pinion 126. That is, the movement 100 constitutes a “two hands timepiece with small second hand” which is provided with the train wheel capable of attaching the hour hand 244, the minute hand 246, the small second hand 340 and in which the rotational center of the hour wheel 244 and the rotation center of the minute wheel 246 are disposed at the same position.

(10) Structure of 24 hour indicating mechanism

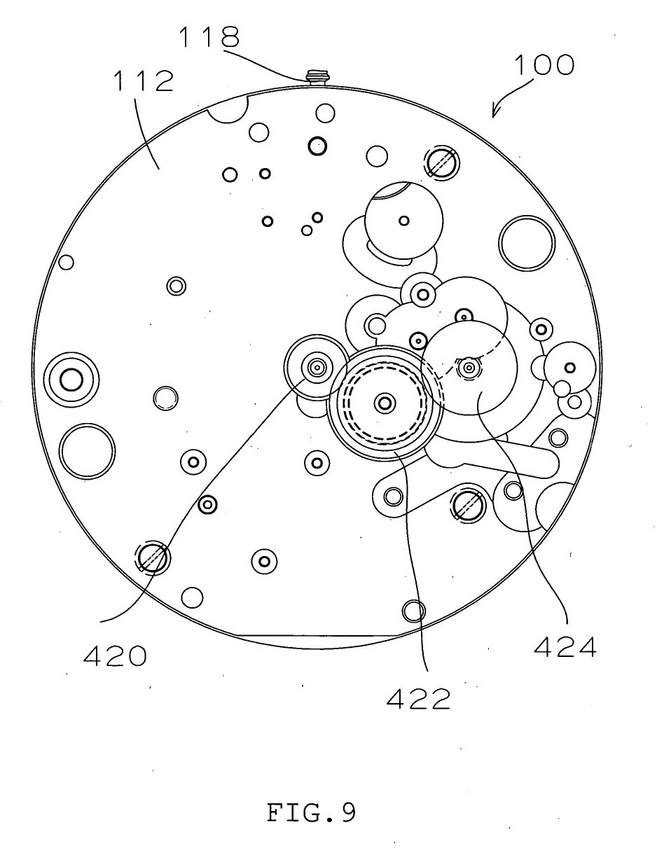

Next, a structure of a 24 hour indicating mechanism will be explained. In reference to FIG. 9 and FIG. 10, the timepiece with small hand indicating mechanism of the invention can be provided to the movement 100 with a mechanism in which “hour” is indicated to constitute 24 hours by one turn by a small hand (referred to as “24 hour system”) without integrating the date feeding mechanism, the date correcting mechanism, the small second hand mechanism (referred to as “24 hour indicating mechanism”). The 24 hour indicating mechanism for indicating “hour”. by “24 hour system” is constituted to be operated based on rotation of the back train wheel by the small hand. The 24 hour indicating mechanism includes a 24 hour intermediate wheel 420, a 24 hour feeding wheel 422, and a 24 hour wheel 424. The 24 hour intermediate wheel 420 is constituted to be integral with the hour wheel 232. Therefore, the 24 hour intermediate wheel 420 is constituted to rotate by rotating the hour wheel 232. A dimension and a shape of the 24 hour intermediate wheel 420 can be constituted to be the same as those of the above-described date corrector setting transmission wheel 250. The 24 hour feeding wheel 422 includes an upper feeding wheel 422a and a lower feeding wheel 422b. The upper feeding wheel 422a is constituted to be brought in mesh with the 24 hour intermediate wheel 420. A position of a rotational center of the 24 hour feeding wheel 422 can be constituted to be disposed at a position the same as a position of the rotational center of the above-described date corrector setting wheel 251. The 24 hour feeding wheel 422 is arranged rotatably to the second main plate 112. The upper feeding wheel 422a and the lower feeding wheel 422b are arranged between the second main plate 112 and the second train wheel bridge 256. A center hole of the 24 hour feeding wheel 422 is rotatably integrated to a shaft portion provided at the second main plate 112.

The 24 hour feeding wheel 422 is constituted to rotate by rotating the 24 hour intermediate wheel 420. The 24 hour wheel 424 is constituted to rotate by rotating the 24 hour feeding wheel 422. The lower feeding wheel 422b is constituted to be brought in mesh with a wheel portion of the 24 hour feeding wheel 422. The 24 hour wheel 424 is constituted to rotate by one rotation by 24 hours. The 24 hour wheel 424 is arranged rotatably to the second main plate 112 and the second train wheel bridge 256. A lower shaft portion of the 24 hour wheel 424 is rotatably integrated to a bearing portion provided at the second main plate 112. An upper shaft portion of the 24 hour wheel 424 is rotatably integrated to a bearing portion provided at the second train wheel bridge 256. The wheel portion of the 24 hour wheel 424 is arranged between the second main plate 112 and the second train wheel bridge 256. It is preferable to arrange the rotational center of the 24 hour wheel 424 in “6 o'clock direction” between the rotational center of the center wheel & pinion 122 and the outer peripheral portion of the main plate 102. The rotational center of the 24 hour wheel 424 is arranged at a position the same as that of the rotational center of the above-described small second wheel 316 and arranged at a position the same as that of the rotational center of the above-described date star wheel 252.

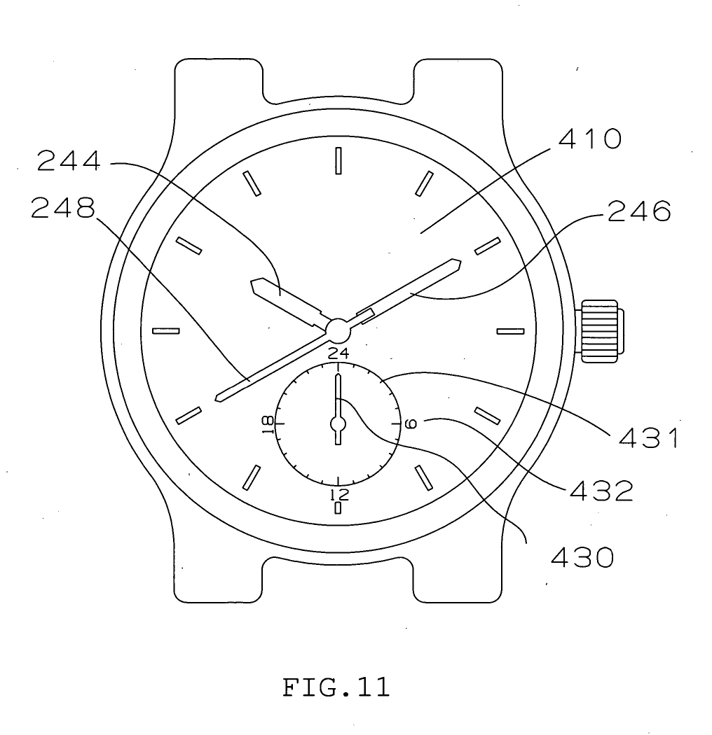

In reference to FIG. 11, a 24 hour hand 430 attached to the 24 hour wheel 424 is constituted to indicate “hour” in “24 hour system”. It is preferable to arrange a position of the rotational center of the 24 hour hand 430 in “6 o'clock direction” between the rotational center of the center wheel & pinion 122 and the outer peripheral portion of the main plate 102. Pluralities of abbreviated letters 431 and numerals 432 for indicating “hour” are provided at a dial 410. For example, the numerals 432 are constituted by “6”, “12”, “18”, “24” or the like. As has been explained above, the movement 100 of the invention can indicate “hour” by the hour hand 244 attached to the hour wheel 232, indicate “minute” by the minute hand 246 attached to the cannon pinion, indicate “second” by the second hand 248 attached to the fourth wheel & pinion 126 and indicate “hour” by “24 hour system” by the 24 hour hand 430 fixed to the hour wheel 424 the rotational center of which is arranged in “6 o'clock direction”. That is, the movement 100 constitutes a “middle three hands timepiece with 24 hour indication” which is provided with the train wheel capable of attaching the hour hand 244, the minute hand 246 and the second hand 248 and in which the rotational center of the hour hand 244, the rotational center of the minute hand 246 and the rotational center of the second hand 248 are disposed at the same position.

(11) Structure of train wheel

As described above, according to the timepiece with small hand indicating mechanism of the invention, the movement 100 is constituted to be provided with a first train wheel rotational center for a train wheel of a first type for operating a first small hand rotated by a first speed, and a second train wheel rotational center for a train wheel of a second type for operating a second small hand rotated by a second speed at a rotational center the same as that of the above-described small hand. The first rotational center of the first small hand is arranged at a position between the main plate center 102c of the main plate 102 and the main plate outer shape portion of the main plate 102. The first train wheel rotational center is provided with a train wheel guide portion (shaft portion, bearing portion, pin and the like) for rotatably guiding a train wheel member rotated centering on the position. The second train wheel rotational center is provided with a train wheel guide portion (shaft portion, bearing portion, pin and the like) for rotatably guiding a train wheel member rotated centering on the position. A train wheel for indicating time information (hour, minute, second, hour of 24 hour system or the like) or calendar information (date, day, lunar age or the like) can rotatably be arranged at one of the first train wheel rotational center and the second train wheel rotational center. Time information or calendar information can be indicated by a small hand rotated by the first type of train wheel or the second type of train wheel by constituting a rotational center by a position between the main plate center 102cand the outer shape portion of the main plate 102.

The second main plate 112 is provided with a train wheel guide portion (shaft portion, bearing portion, pin and the like) for forming a “middle three hands timepiece” arranged with a date hand in “6 o'clock direction”; a train wheel guide portion (shaft portion, bearing portion, pin and the like) for forming a “middle three hands timepiece” arranged with a small second hand in “6 o'clock direction”, and a train wheel guide portion (shaft portion, bearing portion, pin and the like) for forming a “middle three hands timepiece” arranged with a 24 hour hand in “6 o'clock direction”. The second train wheel bridge 256 is provided with a train wheel guide portion (shaft portion, bearing portion, pin and the like) for forming a “middle three hands timepiece” arranged with a date hand in “6 o'clock direction”, a train wheel guide portion (shaft portion, bearing portion, pin and the like) for forming a “middle three hands timepiece” arranged with a small second hand in “6 o'clock direction”, and a train wheel guide portion (shaft portion, bearing portion, pin and the like) for forming a “middle three hands timepiece” arranged with a 24 hour hand in “6 o'clock direction”. By the constitution, a plurality of kinds of movement layouts can be formed by only changing specifications of portions of parts without changing dimensions and shapes of a number of essential parts of the movement.

Although an explanation will be given of the timepiece with small hand indicating mechanism of the invention with regard to the embodiment of the mechanical timepiece, the structure of the timepiece with small hand indicating mechanism of the invention is also applicable to an analog electronic timepiece. Although an explanation has been given of the timepiece with small hand indicating mechanism of the invention with regard to the embodiment arranged with the rotational center of the small hand in “6 o'clock direction”, a structure of the timepiece with small hand indicating mechanism of the invention is also applicable to a timepiece arranged with the rotational center of the small hand in “3 o'clock direction”, “9 o'clock direction”, “12 o'clock direction”, or other arbitrary direction.

By the invention, there can be formed a plurality of kinds of movement layouts having different revolution numbers by only changing specifications of parts without changing dimensions and shapes of a number of essential parts of the movement. That is, by the invention, there can be realized a timepiece with small hand indicating mechanism capable of indicating different information (date indication by a date hand, second indication by a small second hand, time information in 24 hour system by a 24 hour hand and the like) at the same rotational center by changing to integrate portions of parts. Further, by the invention, there can be realized a timepiece with small hand indicating mechanism which does not need much time in switching part working operation and in which a number of fabricating parts is small.

The timepiece with small hand indicating mechanism of the invention can form a plurality of kinds of movement layouts by only changing specifications of portions of parts without changing dimensions and shapes of a number of essential parts of the movement. Further, according to the timepiece with small hand indicating mechanism of the invention, much time is not needed in switching part working operation, a number of steps of fabricating parts is small and therefore, a plurality of kinds of movement layouts can be formed with excellent production efficiency.

What is claimed is:

1. A timepiece with small hand indicating mechanism comprising:
a main plate constituting a base plate of a movement;
a winding stem for correcting indication;
a switching mechanism for switching a position of the winding stem;
a dial for indicating time information; and
a small hand for indicating time information or calendar information;
wherein the movement is provided with a first train wheel rotational center for a first type of a train wheel for operating a first small hand rotated by a first speed, and a second train wheel rotational center for a second type of a train wheel for operating a second small hand rotated by a second speed at a rotational center the same as the rotational center of the small hand;
wherein the first rotational center of the first small hand is arranged at a position between a main plate center of the main plate and a main plate outer shape portion of the main plate;
wherein the first train wheel rotational center is provided with a train wheel guide portion for rotatably guiding a train wheel member rotated centering on the position;
wherein the second train wheel rotational center is provided with a train wheel guide portion for rotatably guiding a train wheel member rotated centering on the position;
wherein a train wheel for indicating the time information or the calendar information is arranged rotatably at one of the first train wheel rotational center and the second train wheel rotational center; and
wherein the time information or the calendar information is constituted to indicate by the small hand rotated by the first type of the train wheel or the second type of the train wheel by constituting a rotational center by the position between the main plate center and the outer shape portion of the main plate.

2. A timepiece with small hand indicating mechanism according to claim 1, wherein the first type of the train wheel is a train wheel constituting a date feeding mechanism indicating “date” by a first small hand, and the second type of the train wheel is a train wheel constituting a small second hand mechanism for indicating “second” by a second small hand.

3. A timepiece with small hand indicating mechanism according to claim 2, wherein the train wheel constituting the small second hand mechanism includes a second transmission wheel rotated integrally with a wheel constituting a top train wheel.

4. A timepiece with small hand indicating mechanism according to claim 1, wherein the first train wheel rotational center can be integrated with a train wheel constituting a date feeding mechanism.

5. A timepiece with small hand indicating mechanism according to claim 4, wherein the train wheel constituting the date feeding mechanism includes an intermediate date indicator driving wheel rotated integrally with an hour wheel.

6. A timepiece with small hand indicating mechanism according to claim 1, wherein the first train wheel rotational center can be integrated with a train wheel constituting a 24 hour indicating mechanism.

7. A timepiece with small hand indicating mechanism according to claim 6, wherein the train wheel constituting the 24 hour indicating mechanism includes a 24 hour intermediate wheel rotated integrally with an hour wheel.
